(19) United States
(12) Patent Application Publication
(10) Pub. No.: US 2008/0279055 A1
(43) Pub. Date: Nov. 13, 2008

(54) Communication Optical Write Strategies Via Central Databases

(75) Inventor: Rudolf Johan Maria Vullers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/568,002

(22) PCT Filed: Apr. 11, 2005
(86) PCT No.: PCT/IB05/51187

§ 371 Date: Oct. 17, 2006

(30) Foreign Application Priority Data
Apr. 20, 2004 (EP) 04101620.5
Nov. 19, 2004 (EP) 04105913.0

(51) Int. Cl. G11B 7/085

(52) U.S. Cl. 369/30.26

(57) ABSTRACT

The present invention relates to an optical drive (10) suitable to write optical storage discs and comprising means for accessing at least one central database (14) which may be accessed by a plurality of optical drives to derive write strategy information assigned to known disc types. In accordance with the present invention the optical drive (10) is adapted to provide said central database (14) with at least a part of disc type identification information obtained from an inserted disc (16), if said inserted disc (16) is of an unknown disc type. Furthermore, the present invention relates to a method for determining the write strategy of an optical drive (10).

### FIELD OF THE INVENTION

The present invention relates to an optical drive suitable to write optical storage discs and comprising means for accessing at least one central database which may be accessed by a plurality of optical drives to derive write strategy information assigned to known disc types. Furthermore, the present invention relates to a method for determining the write strategy of an optical drive, said method comprising the following steps: a) obtaining disc type identification information from a disc inserted into said optical device; and b) determining whether said inserted disc is a disc of a known type on the basis of said disc type identification information.

### BACKGROUND OF THE INVENTION

In connection with optical drives, for example CD-R(W), DVD±(W) or BD-R(e), it is very important to be able to write or record as many inserted discs as possible. A problem in this context is that discs distributed by different manufacturers very often have different characteristics as regards the necessary write strategy. Discs requiring different write strategies are referred to as discs of different types herein. If the optical drive is not able to find a suitable write strategy, the simplest way to proceed is to reject the disc. However, each time a disc is rejected by the optical drive, the user in many cases will blame the optical drive and not the inserted disc.

One first attempt to solve this problem is to increase the writability by storing suitable write strategies for different disc types in a local database of the optical drive. Such a known first attempt is shown in the flowchart in accordance with FIG. 1.

As soon as a disc is inserted in step S1, disc type identification information which is provided on every disc is read by the optical drive to identify the type of the inserted disc in step S2. This disc type identification information is for example known as ADIP (Address In Pre-groove) to the person skilled in the art. Then, the local database (memory) is searched for an entry matching the disc type identification information in step S3. If the disc type is found in the local database, in step S4 the disc is regarded as a disc of a known type and it is proceeded to step S5. In step S5 it is checked whether the speed v_{recording} the user wants to record at is lower than or equal to the maximum speed vₘₐₓ the disc is designed for, wherein this maximum speed vₘₐₓ is obtained via the disc type identification information. If the speed v_{recording} the user wants to record at is higher than the maximum speed vₘₐₓ, in step S6 the write strategy WS suitable for the inserted disc and stored in the local database is used. If the speed v_{recording} the user wants to record at is lower than or equal to the maximum speed vₘₐₓ, in step S9 the write strategy WS is obtained via the disc type identification information. In both cases, in step S10 the write strategy WS parameters are optimised and the disc is written is step S11. However, if in step S4 the disc type of the inserted disc is not found in the local database, it is proceeded to step S7. In step S7 it is also determined whether the speed v_{recording} the user wants to record at is lower than or equal to the maximum speed vₘₐₓ the disc is designed for. If this is not the case, the disc is rejected in step S8. Only if it is determined in step S7 that the speed v_{recording} the user wants to record at indeed is lower than or equal to the maximum speed vₘₐₓ the disc is designed for, it is branched to step S9 where the write strategy WS is obtained via the disc type identification information as described above.

A problem with this approach is that the local database in this case is filled by the manufacturer. Therefore, the local database is not complete since there are many disc types that do not comply with the standard. Furthermore, the local database does not contain disc types coming on the market after the optical drive is fabricated. As a result, with this first attempt, during time more and more discs inserted by the user will be rejected by the optical drive, and this will annoy the user.

To overcome the problems that still exist with the above first attempt, the user in accordance with a second attempt is provided with the possibility to update the local database. This can be achieved by flashing the optical drive for example with a flash disc. Another possibility is to update the local database on the basis of a central database which may be accessed by a plurality of optical drives (for example via the internet) as proposed in US 2003/0123355 A1.

A third, more successful attempt to solve the above mentioned problem is to provide optical drives that have the ability to learn and are therefore called “smart drives”. FIG. 2 illustrates the operation of such a smart optical drive.

As soon as a disc is inserted in step S1 of FIG. 2, also with this third attempt, disc type identification information (ADIP) is read by the optical drive to identify the type of the inserted disc in step S2. Then, the local database is searched for an entry matching the disc type identification information in step S3. If the disc type is found in the local database, in step S4 the disc is regarded as a disc of a known type and it is proceeded to step S5. In step S5 the write strategy WS is obtained via the local database. Then, in step S6 the write strategy WS parameters are optimized. In step S11 the write settings, for example tilt etc., are optimized, and the disc is written in step S12. If in step S4 it is determined that a disc of an unknown type is inserted into the optical drive, in contrary to the above first and second attempts with the third attempt the optical drive tries to write the inserted disc of the unknown type. In this context in step S7 the disc type identification information (ADIP) is used and in step S8 the best possible write strategy WS is determined. If this best write strategy WS is within a spec at step S9, it is branched to step S6 where the respective write strategy WS parameters are optimized, as explained above. In case of such a successful attempt to write the inserted disc of an unknown type, the local database is updated on the basis of the respective experiences, i.e. the optical drive in such a case has learned how to write the disc of the inserted type. The next time when a disc of this type is inserted, the optical device already knows this disc type in step S4. Only if in step S9 it is determined that the best write strategy WS is not within the spec, the disc is rejected in step S10.

With the attempts explained above the number of discs rejected by an optical drive may be reduced considerably, but it might still be regarded as being too high by some users.

On the other hand there exists a problem in that in the worst case the combination of a specific drive design and a specific disc design may lead to the result that trying to write to the disc leads to a (self) destruction of the drive (damage of the optical unit, laser burn out).

It is therefore the object of the present invention to further develop the optical drives and the methods mentioned at the beginning such that the number of discs rejected by an optical drive is further reduced to the absolute necessary minimum.

### SUMMARY OF THE INVENTION

This object is solved by the features of the independent claims. Further developments and preferred embodiments of the invention are outlined in the dependent claims.

In accordance with a first aspect of the present invention, an optical drive of the type mentioned at the beginning is characterized in that it is adapted to provide said central database with at least a part of disc type identification information obtained from an inserted disc, if said inserted disc is of an unknown disc type. Whether the disc is of a known or an unknown type may be determined on the basis of the central database and/or on the basis of a local database, as will be explained in more detail below. By this solution it is ensured that it is immediately noticed at the central database, if a disc of a new type enters the market. Therefore, for example people at a test facility are able to test the new disc type and to update the central database with a suitable write strategy for this new disc type. In the worst case it is discovered at the test facility that the combination of the new disc type and the optical drive is catastrophic and might lead to a drive damage. In this case the only possible write strategy WS information is that the disc has to be rejected to prevent a drive damage. After the update of the central database all optical drives that access the central database may benefit from the new entry.

In accordance with a highly preferred embodiment of the optical drive in accordance with the present invention the optical drive is further adapted to provide said central database with experiences made by trying to write to said inserted disc, particularly to an inserted disc of an unknown disc type. Thereby, it is for example also possible for the central database to provide write strategy information that does not also depend on the disc type but also on the type of optical drive. Furthermore, with this solution an optical drive is enabled not only to learn from itself, but also from other optical drives that supply the central database with data. Another advantage of the network built up in this way is that older optical drives profit from newer, more intelligent optical drives, since in essence the network is as smart as the most intelligent optical drives. Therefore, such an optical drive may be called an “ultra smart optical drive” compared to the “smart optical drives” mentioned above.

In this context it is possible that said experiences comprise write strategy WS information that was successfully applied to said inserted disc. By this solution the test facility mentioned above may for example be omitted.

However, it is also preferred that said experiences comprise write strategy WS information that was not successfully applied, particularly if trying to write lead to a damage of the optical drive.

In this connection said write strategy WS information comprises at least one bit indicating whether the inserted disc has to be rejected.

With preferred embodiments of the optical drive in accordance with the present invention it comprises a local database containing write strategy WS information for at least some known disc types. However, if access to the central database is possible without problem for example via the internet, it is also possible that only the central database is used, even if this is not preferred.

If the optical drive comprises a local database, it is preferred that the optical device is adapted to update its local database on the basis of said central database.

Furthermore it is preferred in this context that the optical device is adapted to update its local database on the basis of said experiences. This may be achieved for example as outlined with reference to FIG. 2 at the beginning.

For all embodiments of the optical drive in accordance with the present invention it is preferred that for writing to said inserted disc, it uses write strategy WS information that is stored in said local database and/or in said central database, if said inserted disc is a disc of a known type.

In accordance with a further embodiment of the present invention, an optical drive of the type mentioned at the beginning is characterized in that it is adapted to reject an inserted optical storage disc of a known disc type, if it derives from said write strategy WS information that writing to an inserted disc might lead to a damage of said optical drive.

The central database preferably is contacted via the internet. In this case an internet controlled emergency brake is realized to prevent a disc damage. The connection to the central database can be made on a regular basis and/or at the time a disc of a unknown type is inserted. As with all embodiments mentioned herein, the user preferably can decide whether internet connections are made automatically or not. The central database is for example filled by data coming from a test facility. At this facility people are testing new discs and are looking for catastrophic discs that might lead to a drive damage. This solution may be referred as a passive solution. However, there further exists an active solution wherein the central database is (also) filled by data provided by optical drives. This active solution will be described in greater detail with reference to FIG. 6.

In any case it is preferred that the optical drive comprises a local database containing write strategy WS information for at least some known disc types.

In this connection it is preferred that the optical drive is adapted to update its local database on the basis of said central database.

The write strategy WS information preferably comprises at least one bit indicating whether the inserted disc has to be rejected.

In accordance with a second aspect of the present invention the method for determining the write strategy of an optical drive mentioned at the beginning is characterized by the following step: c) providing a central database which may be accessed by a plurality of optical drives with at least a part of said disc type identification information, if said inserted disc is of an unknown disc type. By such a method the same advantageous and characteristics as with the optical drive in accordance with the invention are achieved. Therefore, to avoid repetitions, at this point reference is made to the corresponding above explanations in connection with the optical drive in accordance with the invention.

The same applies for the following features characterizing preferred embodiments of the method in accordance with the invention.

Preferably, the method comprises the following additional steps: d) if said inserted disc is a disc of a unknown type, trying to write to said inserted disc with a write strategy WS determined on the basis of said disc type identification information; and e) if trying to write to said inserted disc in said step d) was successful, providing said central database with write strategy information used to successfully write to said inserted disc.

Alternatively or additionally it is possible that the method further comprises the following steps: d) if said inserted disc is a disc of an unknown type, trying to write to said inserted disc with a write strategy WS determined on the basis of said disc type identification information; and f) if trying to write to said inserted disc in said step d) was not successful, providing said central database with experiences made by trying to write to said inserted disc. In this connection unsuccessful attempts to write may be divided into two error classes: Soft errors and drive failure. Soft errors result in a not well-written disc, without any harm done to the drive. For example, the laser power of the drive is insufficient to write the disc at the right power. Drive failure means that part of the drive is malfunctioning as a result of the writing procedure and that the drive should be serviced. For example, this can be a broken laser or overheated chip. The information of the type of drive and the disc ID in such a case is preferably send to the central database. This means that all discs of this type will not be burned by similar drives. For example, a test facility can now take a look at these discs and see if the problem is specific to that single drive or specific to the drive type.

Furthermore, it is preferred that said step b) comprises accessing a local database and/or said central database.

In accordance with a further embodiment of the present invention the method for determining the write strategy of an optical drive mentioned at the beginning is characterized in that in said step b) determining whether said inserted disc is a disc of a known type is performed on the basis of a local database which is updated via the internet, and in that said step b) comprises rejecting said inserted disc without trying to write to it, if it is a disc of a known type which might lead to a drive damage. Also in this case an internet controlled emergency brake is realized to protect the drive.

These and other aspects of the invention will be apparent from and elucidated with reference to the embodiments described hereinafter.

### BRIEF DESCRIPTION OF THE DRAWINGS

FIG. 1 is a flowchart illustrating a first attempt to solve the object of the invention in accordance with the prior art;

FIG. 2 is a flowchart illustrating a third attempt to solve the object of the invention in accordance with the prior art;

FIG. 3 is a flowchart illustrating a preferred embodiment of the method in accordance with the present invention;

FIG. 4 is a schematic diagram illustrating a network of a plurality of optical drives and a central database;

FIG. 5 is a simplified block diagram illustrating an embodiment of the optical drive in accordance with the present invention; and

FIG. 6 is a flowchart illustrating a further preferred embodiment of the method in accordance with the present invention.

### DESCRIPTION OF PREFERRED EMBODIMENTS

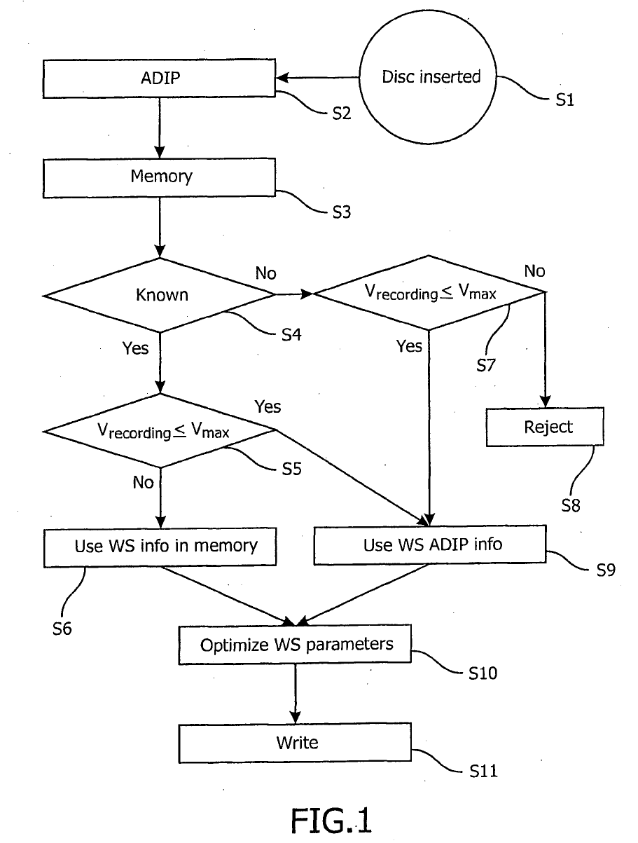

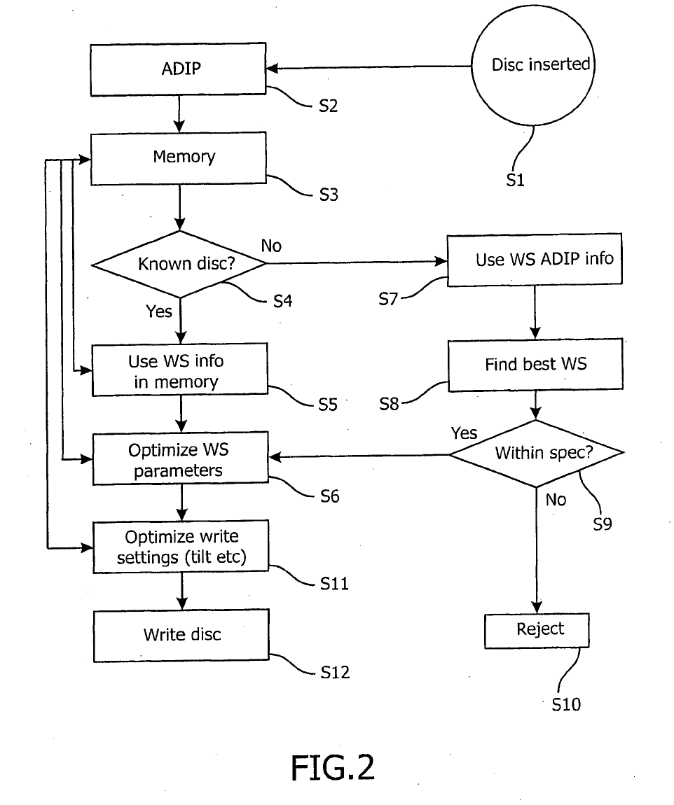

FIGS. 1 and 2 which illustrate first and third attempts in accordance with the prior art were already explained in the introduction to the description.

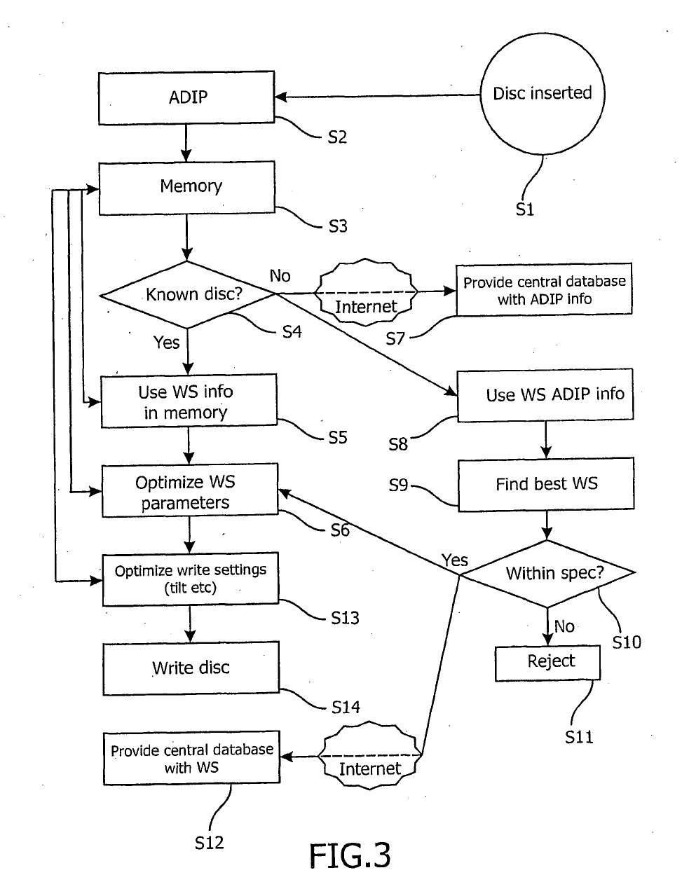

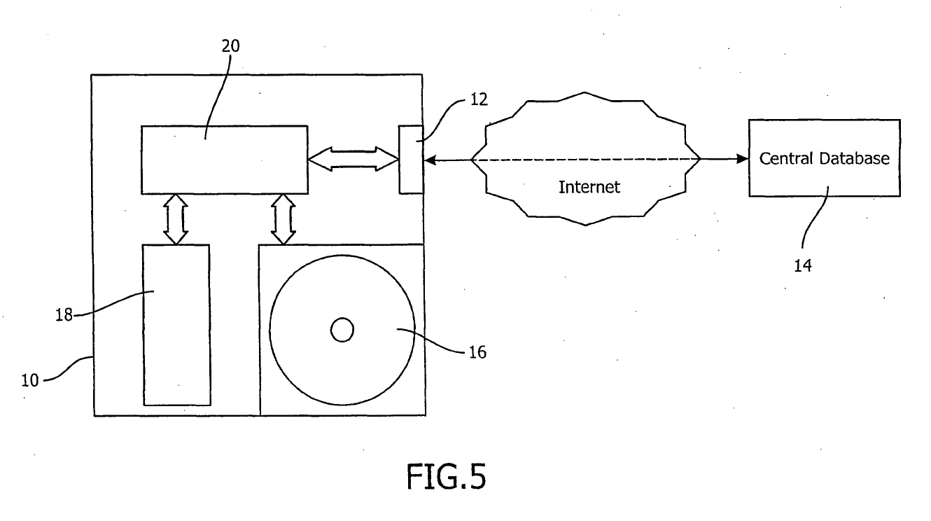

FIG. 3 is a flowchart illustrating a preferred embodiment of the method in accordance with the present invention, wherein the reference numerals used in the following are directed to FIG. 5 which is explained later. When a disc 16 is inserted in step S1 of FIG. 2, disc type identification information is read by the optical drive 10 to identify the type of the inserted disc in step S2. The disc type identification information particularly may be the ADIP. Then, the local database 18 is searched for an entry matching the disc type identification information in step S3. If the disc type is found in the local database 18, in step S4 the inserted disc 16 is regarded as a disc of a known type and it is proceeded to step S5. In step S5 the write strategy WS is obtained via the local database 18. Then, in step S6 the write strategy WS parameters are optimized. In step S13 write settings, for example tilt etc, are optimized, and the disc is written in step S14.

If in step S4 it is determined that a disc 16 of a unknown type is inserted into the optical drive 10, the optical drive 10 contacts a central database 14 via the internet to provide the central database 14 with the disc type identification information.

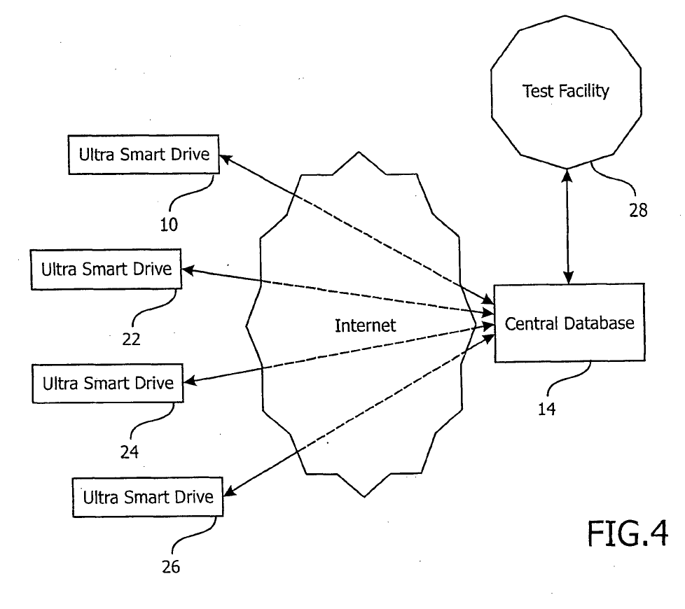

If a network (see FIG. 4) is formed by a plurality of optical drives 10, 22, 24, 26 operating in this way and at least one central database 14 which may be accessed by the plurality optical drives 10, 22, 24, 26, it is ensured that it is immediately noticed when a disc of a new disc type enters the market. If such a disc of a new type is detected, a suitable write strategy WS may be determined for example by a test facility 28 which provides the central database 14 with the respective information.

Referring back to FIG. 3, in step S8 the disc type identification information (ADIP) is used and in step S9 the best possible write strategy WS is determined. Only if in step S10 it is determined that the best write strategy WS is not within the spec, the disc is rejected in step S11. However, if this best write strategy WS is within the spec at step S10, the central database 14 at step S12 is provided with the determined best write strategy WS for the inserted disc 16, i.e. with the experiences made by successfully trying to write to the inserted disc 16. From this moment on, the inserted disc 16 may be handled as a disc of a known type by the whole network. Furthermore, it is branched to step S6 where the write strategy WS parameters are optimized before in step S13 write settings are optimized. Finally, in step S14 the inserted disc is written. As it is indicated by the arrows between steps S3, S5, S6 and S13, the optical drive 10 not only provides the central database 14 with its experiences, but also updates its local database (memory) accordingly.

FIG. 5 is a simplified block diagram illustrating an embodiment of the optical drive 10 in accordance with the present invention. The optical drive 10 comprises a read/write unit to which a disc 16 is inserted. The whole optical drive 10 is controlled by a controller 20, as indicated by the respective arrows. Furthermore, the optical drive 10 comprises means 12 (for example a modem) adapted to access a central database 14 containing write strategy WS information at least for different disc types but in some cases possibly also for different types of optical drives, as mentioned above. The optical drive 10 shown in FIG. 5 comprises a local database 18 which also contains write strategy WS information for different disc types, wherein this local database is updated on the basis of both, the central database 14 and experiences made by the optical drive 10. Since the optical drive 10 shown in FIG. 5 is not only able to learn by itself (smart drive) but also from all optical drives 10, 22, 24, 26 (FIG. 4), the optical drive 10 in accordance with FIG. 5 may be called an “ultra smart drive”.

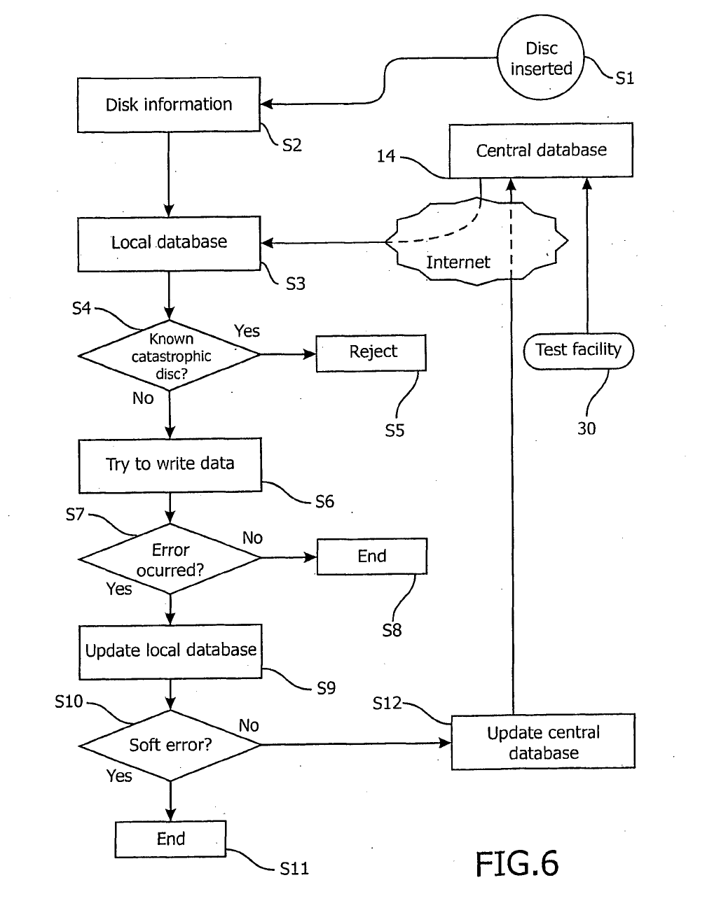

FIG. 6 is a flowchart illustrating a further preferred embodiment of a method in accordance with the present invention, wherein the reference numerals used in the following are again directed to FIG. 5 already explained. The method illustrated in FIG. 6 is an active solution for realizing an emergency brake to protect the drive against catastrophic discs, i.e. discs which might lead to a damage of the drive if a writing process is carried out. In cases where it is determined that no catastrophic disc is inserted, i.e. in the absolute plurality of cases, the method according to FIG. 3 preferably is carried out simultaneously or afterwards to optimize the writing process.

When a disc 16 is inserted in step S1 of FIG. 6, disc type identification information is read by the optical drive 10 to identify the type of the inserted disc in step S2. The disc type identification information particularly may be the ADIP. Then, the local database 18 is searched for an entry matching the disc type identification information in step S3. The local database 18 contains at least write strategy WS information directed to the question whether a disc is catastrophic or not. However, with preferred embodiments the local database 18 also contains write strategy WS information which is suitable to optimize the write strategy WS, if a disc is not catastrophic, for example as discussed in connection with FIG. 3. The local database 18 is updated by a central database 14 on a regular basis. Although not shown in FIG. 6, it is also possible to update the local database 18 each time when an inserted disc 16 is of an unknown type. If it is determined in Step S4 that the inserted disc 16 is of a known type and is catastrophic, the inserted disc is rejected in step S4 to protect the drive. If the inserted disc 16 is not known to be catastrophic, in step S6 it is tried to write the disc. If it is determined in step S7 that no error occurred, everything is fine and the method ends in step S8. If an error occurred, the local database 18 is updated in step S9 with the experiences made by the attempt to write. Then the kind of error is investigated in step S10. If a so called soft error occurred, i.e. an error that resulted in a not well-written disc but did not damage the drive, the illustrated method ends in step S11. Otherwise, if no soft error but a drive failure occurred, i.e. the drive was damaged, the central database 14 is updated accordingly via the internet in step S12. In accordance with the illustration of FIG. 6, the central database 14 is additionally updated by a test facility 30. For example, the test facility 30 takes a look at all discs reported to be catastrophic to see if the problem was specific to that single drive or specific to the drive type. In cases where the problem was specific only to a single drive the entry that the disc type is catastrophic will be removed from the central database 14 to reduce the number of disc rejections.

Although not shown in FIG. 6, it is also possible that the drive informs the central database 14 not only in cases where a drive failure occurred, but in all cases where an unknown disc type was inserted or at least in all cases where any error occurred in the attempt to write to an unknown disc type.

The invention can be applied to all optical drives, which have access to a central database, particularly via the internet. This means at least all PC drives and drives mounted in stand-alone products connected to the internet.

Finally it is to be noted that equivalents and modifications not described above may also be employed without departing from the scope of the invention, which is defined in the accompanying claims.

1-18. (canceled)

19. An optical drive (10) suitable to write optical storage discs and comprising means (12) for accessing at least one central database (14) which may be accessed by a plurality of optical drives (10, 22, 24, 26) to derive write strategy WS information assigned to known disc types, characterized in that it is adapted to provide said central database (14) with at least a part of disc type identification information obtained from an inserted disc (16), if said inserted disc (16) is of an unknown disc type, the optical drive further being adapted to provide said central database (14) with experiences made by trying to write to said inserted disc (16).

20. The optical drive according to claim 19, characterized in that said experiences comprise write strategy WS information that was successfully applied to said inserted disc (16).

21. The optical drive according to claim 19, characterized in that said experiences comprise write strategy WS information that was not successfully applied, particularly if trying to write lead to a damage of the optical drive.

22. The optical drive according to claim 19, characterized in that said write strategy WS information comprises at least one bit indicating whether the inserted disc (16) has to be rejected.

23. The optical drive according to claim 19, characterized in that it comprises a local database (18) containing write strategy WS information for at least some known disc types.

24. The optical drive according to claim 23, characterized in that it is adapted to update its local database (18) on the basis of said central database (14).

25. The optical drive according to claim 23, characterized in that it is adapted to update its local database (18) on the basis of said experiences.

26. The optical drive according to claim 19, characterized in that for writing to said inserted disc (16), it uses write strategy WS information that is stored in a local database (18) and/or in said central database (14), if said inserted disc (16) is a disc of a known type.

27. An optical drive (10) suitable to write optical storage discs and comprising means (12) for accessing at least one central database (14) which may be accessed by a plurality of optical drives (10, 22, 24, 26) to derive write strategy WS information assigned to known disc types, characterized in that it is adapted to reject an inserted disc (16) of a known disc type, if it derives from said write strategy WS information that writing to an inserted disc (16) might lead to a damage of said optical drive.

28. The optical drive according to claim 27, characterized in that it comprises a local database (18) containing write strategy WS information for at least some known disc types.

29. The optical drive according to claim 28, characterized in that it is adapted to update its local database (18) on the basis of said central database (14).

30. The optical drive according to claim 27, characterized in that said write strategy WS information comprises at least one bit indicating whether the inserted disc (16) has to be rejected.

31. A method for determining the write strategy of an optical drive (10), said method comprising the following steps:
a) obtaining disc type identification information from a disc (16) inserted into said optical device;
b) determining whether said inserted disc (16) is a disc of a known type on the basis of said disc type identification information;
said method being characterized by the following step:
c) providing a central database (14) which may be accessed by a plurality of optical drives (10, 22, 24, 26) with at least a part of said disc type identification information, if said inserted disc (16) is of an unknown disc type,
d) if said inserted disc (16) is a disc of an unknown type, trying to write to said inserted disc (16) with a write strategy WS determined on the basis of said disc type identification information; and
e) if trying to write to said inserted disc (16) in said step d) was successful, providing said central database (14) with write strategy WS information used to successfully write to said inserted disc (16).

32. The method according to claim 31, characterized in that it further comprises the following step:
f) if trying to write to said inserted disc (16) in said step d) was not successful, providing said central database (14) with experiences made by trying to write to said inserted disc (16).

33. The method according to claim 31, characterized in that said step b) comprises accessing a local database (18) and/or said central database (14).

34. A method for determining the write strategy of an optical drive (10), said method comprising the following steps:
a) obtaining disc type identification information from a disc (16) inserted into said optical device;
b) determining whether said inserted disc (16) is a disc of a known type on the basis of said disc type identification information;
characterized in that in said step b) determining whether said inserted disc (16) is a disc of a known type is performed on the basis of a local database (18) which is updated via the internet, and in that said step b) comprises rejecting said inserted disc (16) without trying to write to it, if it is a disc of a known type which might lead to a drive damage.
